(19) United States
(12) Patent Application Publication
(10) Pub. No.: US 2009/0164461 A1
(43) Pub. Date: Jun. 25, 2009

(54) RELEVANT ELEMENT SEARCHING APPARATUS AND COMPUTER READABLE MEDIUM

(75) Inventors: Hitoshi Ikeda, Kanagawa (JP); Motofumi Fukui, Kanagawa (JP); Junichi Takeda, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/193,812

(22) Filed: Aug. 19, 2008

(30) Foreign Application Priority Data
Dec. 20, 2007 (JP) 2007-328865

(51) Int. Cl. G06F 17/30

(52) U.S. Cl. 707/5; 707/E17.017

(57) ABSTRACT

A relevant element searching apparatus includes: an acquiring unit that obtains a plurality of data elements; a first producing unit that produces characteristic amount data of each of the data elements; a first classifying unit that classifies the data elements into one or more clusters on the basis of the characteristic amount data produced by the first producing unit; a selecting unit that selects a cluster from the one or more clusters; a second producing unit that, on the basis of data elements belonging to the selected cluster, produces characteristic amount data of each of the data elements; a second classifying unit that classifies the data elements belonging to the cluster into clusters on the basis of the characteristic amount data; and a searching unit that searches at least one of data elements which are classified into a same cluster as the designated data element.

### CROSS-REFERENCE TO RELATED APPLICATIONS

This application is based on and claims priority under 35 U.S.C. 119 from Japanese Patent Application No. 2007-328865 filed Dec. 20, 2007.

### BACKGROUND

1. Technical Field

The present invention relates to a relevant element searching apparatus and a computer readable medium.

2. Related Art

Recently, in accordance with the popularization of computers, a large amount of digitized documents is accumulated in a computer. As the amount of accumulated data is larger, it is more difficult to find worthwhile information from a large amount of digital information accumulated in such a computer, or understand the whole structure of the information. Conventionally, therefore, several techniques for finding a useful document from accumulated data, and presenting it to the user have been proposed.

### SUMMARY

According to a first aspect of the present invention, a relevant element searching apparatus includes: a acquiring unit that obtains a plurality of data elements; a first producing unit that produces characteristic amount data of each of the data elements; a first classifying unit that classifies the data elements into one or more clusters on the basis of the characteristic amount data produced by the first producing unit; a selecting unit that selects a cluster to which a data element that is a designated one of the plural data elements belongs, from the one or more clusters classified by the first classifying unit; a second producing unit that, on the basis of data elements belonging to the selected cluster, produces characteristic amount data of each of the data elements; a second classifying unit that classifies the data elements belonging to the cluster, which is selected by the selecting unit, into clusters on the basis of the characteristic amount data produced by the second producing unit; and a searching unit that, as a relevant data element, searches at least one of data elements which are classified into a same cluster as the designated data element by the second classifying unit.

### BRIEF DESCRIPTION OF THE DRAWINGS

Exemplary embodiment of the present invention will be described in detail based on the following figures, wherein:

FIG. 1 is a functional block diagram of a relevant element searching apparatus of an embodiment; and

FIG. 2 is a flowchart illustrating a series of flows of a relevant element searching process which is performed by the relevant element searching apparatus.

### DETAILED DESCRIPTION

Hereinafter, an exemplary embodiment (hereinafter, referred to as embodiment) which is preferred for implementing the invention will be described with reference to the drawings.

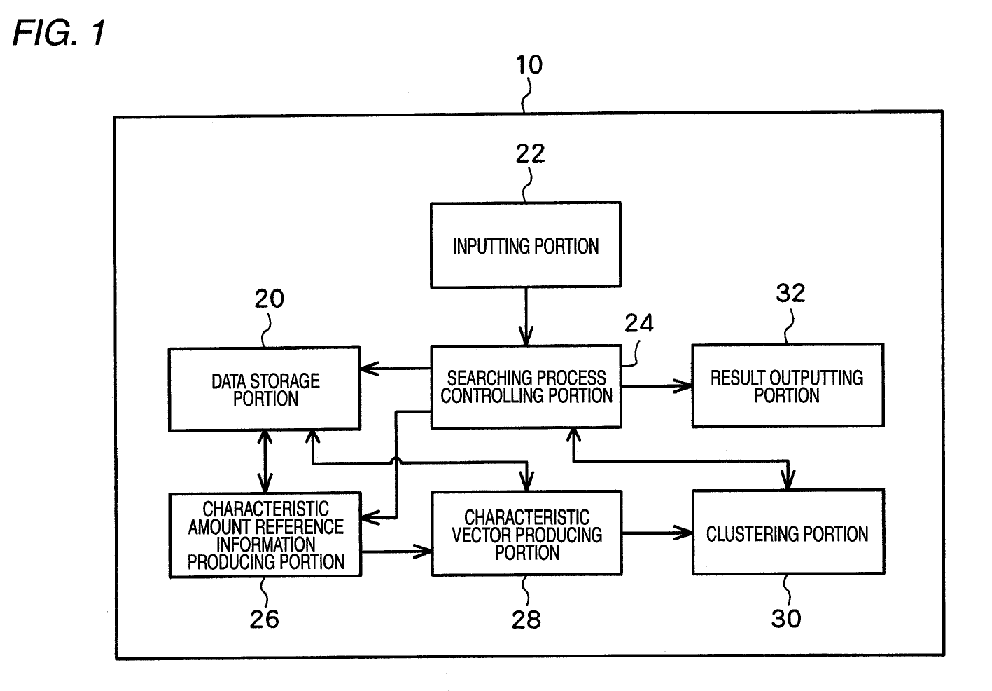

FIG. 1 is a functional block diagram of a relevant element searching apparatus 10 of the embodiment. As shown in FIG. 1, the relevant element searching apparatus 10 includes a data storage portion 20, an inputting portion 22, a searching process controlling portion 24, a characteristic amount reference information producing portion 26, a characteristic vector producing portion 28, a clustering portion 30, and a result outputting portion 32. The functions of the portions may be realized by operating the relevant element searching apparatus 10 which is a computer system, in accordance with computer programs. The computer programs may be stored in an information recording medium of any form which is readable by a computer, such as a CD-ROM, a DVD-ROM, or a flash memory, and read into the relevant element searching apparatus 10 by a medium reading apparatus which is connected to the relevant element searching apparatus 10, and which is not shown. Alternatively, the computer programs may be downloaded to the relevant element searching apparatus 10 through a network.

The data storage portion 20 is configured by a storage device such as a memory or a hard disk drive, and stores plural data elements. In the embodiment, data elements to be processed by the relevant element searching apparatus 10 are digital documents, a digital document which is designated by the user is set as a search key document, and a process of searching a digital document which is highly relevant to the search key document from digital documents stored in the data storage portion 20 (hereinafter, the process is referred to as relevant element searching process) is performed.

The inputting portion 22 receives an input of information into the relevant element searching apparatus 10. The inputting portion 22 receives an input through an information inputting device such as a keyboard or a mouse, and may function also as an interface of receiving data transmitted through a network. The inputting portion 22 receives designation information designating a search key document from the user. In this case, data themselves of a search key document may be received, or a document name or document ID designating one of digital documents stored in the data storage portion 20 may be received.

The searching process controlling portion 24 controls the relevant element searching process which is performed by the relevant element searching apparatus 10. The searching process controlling portion 24 starts the process of searching document data relevant to the digital document designated by the information which is received through the inputting portion 22, and which designates the search key document. First, the searching process controlling portion 24 determines a digital document group to be searched, in the digital documents stored in the data storage portion 20. The search object may be all of the digital documents stored in the data storage portion 20, or restricted on the basis of contents, bibliographic information, a document format, etc.

The characteristic amount reference information producing portion 26 produces reference information for producing characteristic amount data (characteristic vectors) with respect to a data element group designated by the searching process controlling portion 24. In the case where the data elements are digital documents, the reference information may be a keyword group constituted by keywords which are extracted from a digital document group of the search object, or bibliographic information. In the case where the reference information is a keyword group extracted from the digital document group, for example, the characteristic amount reference information producing portion 26 may extract a keyword group characteristic of the digital document group of the search object, in accordance with the following reference.

With respect to a cluster including plural digital documents, the characteristic amount reference information producing portion 26 extracts keywords characteristic of a digital document belonging to the cluster. Also a digital document group which is obtained as the initial state, and which functions as the search population may be regarded as one cluster. As a technique for extracting keywords, various techniques may be employed. For example, a reference in which a keyword appears at a higher frequency in documents belonging to a cluster of interest (specifically, a cluster to which the search key document belongs), and at a lower frequency in documents belonging to other clusters may be used. When a score with respect to a reference Wⱼ in a cluster Cᵢ is indicated by S(i, j), therefore, the value of the score can be calculated by, for example, following Expression (1):

$$S ( i , j ) = F ( i , j ) * {\prod }_{k \neq i}^{ } ( 1.0 - F ( k , j ) ) \qquad ( 1 )$$

where F(i, j) is a value which is obtained by dividing the total number of documents that, among those belonging to a cluster Cᵢ, are those belonging to the cluster Cᵢ, and those include the reference Wⱼ, by the number of documents belonging to the cluster Cᵢ. In Expression (1) above, the score has a larger value as a keyword appears at a higher frequency in a cluster of interest (a cluster to which the search key document belongs), and at a lower frequency in other clusters. In a certain cluster Cᵢ, S(i, j) may be calculated for all references Wⱼ, and a reference Wⱼ in which the calculated score is larger than a predetermined value may be used as reference information W.

The score of a reference Wⱼ may be a value based on the difference between the entropy in a cluster C of the reference Wⱼ and that in other clusters. In this case, a reference Wⱼ in which, in a cluster to which a designated search key document belongs, and other clusters, the difference in information entropy of the reference Wⱼ is not smaller than a predetermined value may be selected as an element of the reference information W.

The characteristic vector producing portion 28 produces characteristic vectors of object data elements on the basis of the reference information produced by the characteristic amount reference information producing portion 26. In the case where the data elements are digital documents and the reference information is a keyword group extracted from the digital documents, characteristic vectors of the digital documents may be produced depending on whether keywords of the keyword group are included in the digital documents or not. Specifically, for example, the case where a keyword Wᵢ (i=1, 2, . . . , n) is included in a digital document Dⱼ (j=1, 2, . . . , N) is indicated by “1”, and the case where the keyword is not included in the digital document is indicated by “0”. A characteristic vector Pⱼ with respect to the digital document Dⱼ is expressed as an n-dimensional vector (0, 1, 1, . . . , 0)^{t}. In the above, n is the number of elements of the keyword group, and N is the number of object digital documents.

The clustering portion 30 classifies data elements into plural clusters on the basis of characteristic vectors of the data elements produced by the characteristic vector producing portion 28. As the algorithm of the clustering, one of known algorithms such as the K-Means method and various hierarchical clustering methods may be used.

The searching process controlling portion 24 selects a data element group which, as a result of the clustering by the clustering portion 30, is classified into the same cluster as the designated data element (search key document), as the next data element group to be processed (hereinafter, referred to as to-be-processed data element group). With respect to the new to-be-processed data element group selected by the searching process controlling portion 24, then, the characteristic amount reference information producing portion 26 produces reference information characteristic of the to-be-processed data element group. Namely, with respect to keywords obtained from a data element group belonging to the same cluster as the selected search key document, scores based on Expression (1) above are respectively calculated, and a keyword group consisting of keywords in which the score is not smaller than the predetermined value is produced. The keyword group functions as reference information in the case where the cluster to which the search key document belongs are further sub-classified into clusters.

On the basis of the reference information (keyword group) which is produced as described above, the characteristic vector producing portion 28 produces a new characteristic vector for each of data elements of the to-be-processed data element group. The clustering portion 30 implements the clustering process on the basis of characteristic vectors of newly produced data element groups.

In addition, one device may operate as both a first producing unit and a second producing unit described in the present claims. Further, one device may operate as both a first classifying unit and a second classifying unit described in the present claims. The following example shows that the characteristic vector producing portion 28 operates as both the first generating unit and the second generating unit, and that the clustering portion 30 operates as both the first classifying unit and the second classifying unit.

The searching process controlling portion 24 determines whether a result of the clustering by the clustering portion 30 satisfies predetermined termination conditions or not, and recursively repeats the clustering process for the cluster to which the search key document belongs, until the predetermined termination conditions are satisfied. The predetermined termination conditions may be selected from various conditions such as that the number of digital documents belonging to the same cluster as the search key document is not larger than a predetermined number, or that the number of keywords which are produced as reference information becomes equal to or smaller than a predetermined umber.

If the searching process controlling portion 24 determines that termination conditions are satisfied, the result outputting portion 32 outputs data element relevant to the designated data element. The output of data element may be performed by displaying the search result in the form of a list on a display device connected to the relevant element searching apparatus 10, or by printing the search result.

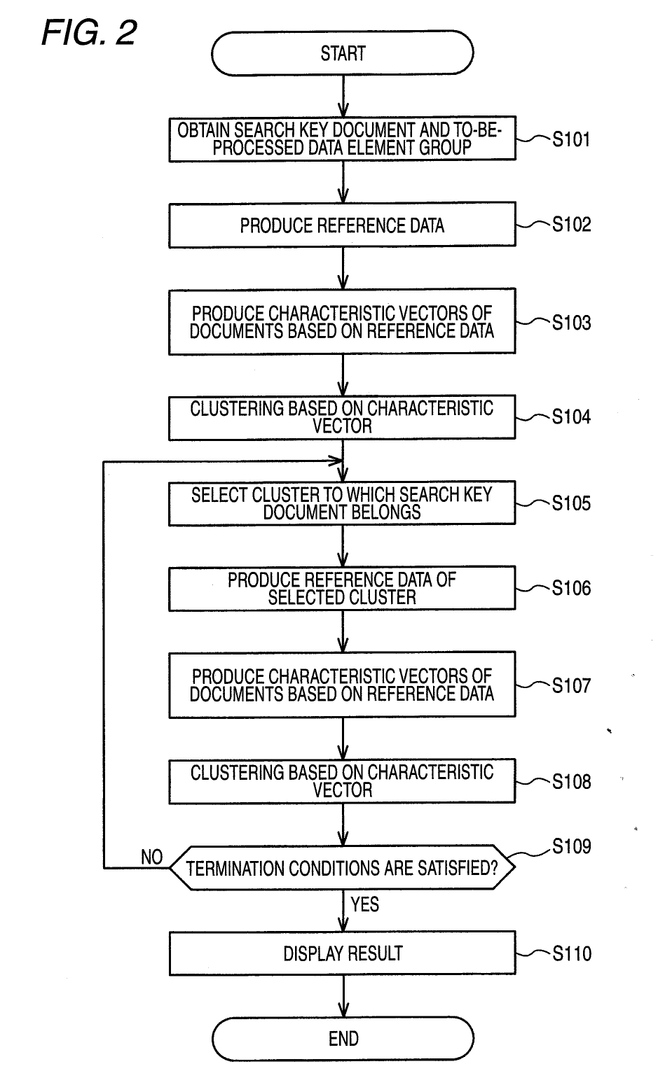

Next, a series of flows of the relevant element searching process conducted by the relevant element searching apparatus 10 of the embodiment will be described with reference to a flowchart shown in FIG. 2.

First, the relevant element searching apparatus 10 obtains the search key document and a document group (to-be-processed data element group) which functions as the search population (S101). The to-be-processed data element group consists of data stored in the data storage portion 20. The search key document may be a document included in the to-be-processed data element group, or a digital document which is newly obtained through the inputting portion 22.

The relevant element searching apparatus 10 extracts a keyword group on the basis of a predetermined reference, from both the obtained search key document and the to-be-processed data element group, and sets the keyword group as reference information (S102). The predetermined reference may be based on conditions such as the degree of frequency and the part of speech. Then the relevant element searching apparatus 10 produces characteristic vectors of each of the search key document and the to-be-processed data element group on the basis of the obtained reference information (keyword group) (S103).

The relevant element searching apparatus 10 classifies the documents into one or more clusters on the basis of the produced characteristic vectors of the documents (S104). The relevant element searching apparatus 10 selects a cluster to which the search key document belongs as a result of the classification (S105).

Next, with respect to the selected cluster (hereinafter, referred to as cluster of interest), the relevant element searching apparatus 10 produces reference information (keyword group) characterizing the cluster of interest (S106). The relevant element searching apparatus 10 may perform the production of reference information by means of calculating the score by Expression (1) above with respect to the keywords extracted from digital documents included in the cluster of interest, and producing a keyword group including keywords as elements in which the calculated score is not smaller than the predetermined value.

The relevant element searching apparatus 10 produces characteristic vectors of digital documents included in the cluster of interest on the basis of the produced reference information (keyword group) (S107). The relevant element searching apparatus 10 further classifies the digital documents of the cluster of interest on the basis of the produced characteristic vectors of the digital documents (S108).

The relevant element searching apparatus 10 determines whether a result of the classification satisfies predetermined termination conditions or not (S109). If, in the determination, it is determined that the predetermined termination conditions are not satisfied (S109: N), the relevant element searching apparatus 10 returns to the process of S105 in which a cluster to which the search key document belongs is selected, and repeats the subsequent processes. If, in the determination, it is determined that the predetermined termination conditions are satisfied (S109: Y), the relevant element searching apparatus 10 outputs a result of the search performed by the relevant element searching process (S110). For example, the search result may be displayed on the display device while forming at least a part of other digital documents belonging to the same cluster as the search key document, into a list format. In the list format, a list may be formed in the order of digital documents in which the characteristic vector is closer in distance to that of the search key document. It is a matter of course that the output format is not restricted to the above and a relevant document group is printed out.

According to the relevant element searching apparatus 10 which has been described above, when a cluster into which the data elements of the search object have been classified is further classified into finer clusters, the clustering is performed while obtaining the characteristic amount data suitable to the current clusters. Therefore, the accuracy of a search of a data element that is highly relevant to a data element of the search object can be improved.

The invention is not restricted to the above-described embodiment, and may of course be variously changed, modified, or replaced by those skilled in the art.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A relevant element searching apparatus comprising:
a acquiring unit that obtains a plurality of data elements;
a first producing unit that produces characteristic amount data of each of the data elements;
a first classifying unit that classifies the data elements into one or more clusters on the basis of the characteristic amount data produced by the first producing unit;
a selecting unit that selects a cluster to which a data element that is a designated one of the plural data elements belongs, from the one or more clusters classified by the first classifying unit;
a second producing unit that, on the basis of data elements belonging to the selected cluster, produces characteristic amount data of each of the data elements;
a second classifying unit that classifies the data elements belonging to the cluster, which is selected by the selecting unit, into clusters on the basis of the characteristic amount data produced by the second producing unit; and
a searching unit that, as a relevant data element, searches at least one of data elements which are classified into a same cluster as the designated data element by the second classifying unit.

2. The relevant element searching apparatus as claimed in claim 1,
wherein
the second producing unit that produces characteristic amount data for each of data elements which are classified into the same cluster as the designated data element, and
the second classifying unit recursively classifies the data elements belonging to the cluster, which is selected by the selecting unit, into clusters on the basis of the produced characteristic amount data is recursively executed until predetermined termination conditions are satisfied.

3. The relevant element searching apparatus as claimed in claim 1,
wherein
the second classifying unit produces characteristic amount data on the basis of reference information constituted by information which is included at a higher probability than data elements belonging to other clusters, in data elements belonging to the selected cluster.

4. The relevant element searching apparatus as claimed in claim 1,
wherein
the second classifying unit produces characteristic amount data on the basis of reference information constituted by information which has a higher entropy than data elements belonging to other clusters, in the elements belonging to the selected cluster.

5. The relevant element searching apparatus as claimed in claim 3,
wherein
the data elements are electronic documents,
the reference information is constituted by keywords extracted from the electronic documents, and
the characteristic amount data are produced depending on whether keywords constituting the reference information are included.

6. The relevant element searching apparatus as claimed in claim 5, further comprising:
a presentation unit that presents the searched relevant data element,
wherein
the characteristic amount data are vector data, and
the presentation unit that presents the searched relevant data element in an order according to a distance of the vector data with respect to the designated data element.

7. A computer readable medium storing a program causing a computer to execute a process for searching a plurality of data elements being highly relevant to a data element of a search object, the process comprising:
obtaining the data elements;
producing characteristic amount data of each of the data elements;
classifying the data elements into one or more clusters on the basis of the characteristic amount data produced in the producing of the characteristic amount data;
selecting a cluster to which a data element that is a designated one of the data elements belongs, from the one or more clusters classified in the classifying of the data elements;
producing characteristic amount data of data elements belonging to the selected cluster;
classifying the data elements belonging to the selected cluster into clusters on the basis of the characteristic amount data produced in the producing of the characteristic amount data of data elements belonging to the selected cluster; and
searching at least one of data elements which are classified into a same cluster as the designated data element in the classifying of the data elements belonging to the selected cluster.
